(19) United States
(12) Patent Application Publication
(10) Pub. No.: US 2009/0056229 A1
(43) Pub. Date: Mar. 5, 2009

(54) Door weatherstrip

(75) Inventors: Satoshi Mugishima, Aichi-ken (JP); Hideaki Minoura, Aichi-ken (JP); Tomonori Inoue, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/230,437

(22) Filed: Aug. 28, 2008

(30) Foreign Application Priority Data
Aug. 29, 2007 (JP) P. 2007-222073
Sep. 12, 2007 (JP) P. 2007-236837

(51) Int. Cl. E06B 7/16

(52) U.S. Cl. 49/493.1

(57) ABSTRACT

A door weather strip is attached round a circumferential edge of a door of an automotive vehicle. An extruded portion 7 which makes up mainly an upper side portion of the door weather strip includes an attaching base portion 15 which is fixed to an inner panel 5 with clip members 13, a hollow main seal portion 16 which is brought into press contact with a circumferential edge of a door opening, a sub-seal lip 25 which is brought into press contact with the circumferential edge of the door opening in a position lying further transversely outwards than the main seal portion 16, a back-side lip 26 which is brought into press contact with a flange portion 27 formed on the circumferential edge of the door, a draining lip 30 which is formed to extend from an external side wall portion 19 of the attaching base portion 15 so as to be brought into press contact with the flange portion 27 and a water stopping rib 33 which is provided on a base bottom portion 17 of the attaching base portion 15 in such a manner as to be brought into press contact with an attaching surface 5b of the inner panel 5.

### BACKGROUND OF THE INVENTION

1. Field of the Invention

The present invention relates to a door weather strip attached round a door of a vehicle.

2. Description of the Related Art

Conventionally, a door weather strip is attached round a circumferential edge of a door of a vehicle such as an automotive vehicle. The door weather strip is formed, for example, of an EPDM (ethylene-propylene-diene terpolymer) rubber and includes a base bottom portion which is fixed to a circumferential edge of a door and a hollow seal portion which is formed integrally with the base bottom portion. Then, when the door is closed, by the seal portion being brought into abutment or press contact with a circumferential edge of a door opening, the door is fastened to a body of the vehicle tightly so as to produce a seal therebetween, whereby the prevention of ingress of rain water or the like into an interior of the vehicle is realized.

In recent years, in order to realize a reduction in weight and production costs, there have been proposed from time to time door seal constructions in which weather strip attaching retainers are omitted from the circumferential edge of the door. In this case, the door weather strip is made to be fixed to the circumferential edge of the door by fixing means such as clips.

However, only with clips which are attached intermittently at predetermined intervals, it becomes difficult to ensure sufficient sealing properties to prevent the ingress of rain water or the like between the base bottom portion of the weather strip and a door panel. Because of this, the sealing properties are enhanced by utilizing in parallel a pressure sensitive adhesive double coated tape which can be affixed continuously in a longitudinal direction and the clips, for example, in an upper side portion of the door.

In addition, with a view to realizing a further reduction in production costs, there has been proposed a technique in which the relatively expensive pressure sensitive adhesive double coated tape is omitted. For example, there is proposed a technique in which a highly foamed sponge member is provided on a rear surface of a base bottom portion of a door weather strip (for example, refer to Patent Document No. 1).

Patent Document No. 1: JP-A-2001-63382

However, the highly foamed sponge member is easy to be deformed plastically and has difficulty in ensuring stable sealing properties over a long period of time. In addition to this, since the highly foamed sponge cannot apply a sufficient sealing pressure to the door panel, there occurs an occasion when the seal is partially broken, leading to a fear that water intrudes into an interior of the vehicle. In particular, in a door panel which is fabricated by welding together panels having different thicknesses, since a difference in level is easy to be produced between the panels so welded, with the highly foamed sponge member which cannot apply the sufficient sealing pressure, the difference in level cannot be taken in and hence, a gap is produced, leading to a fear that a reduction in sealing properties is called for.

### SUMMARY OF THE INVENTION

The invention has been made in view of these situations, and an object thereof is to provide a door weather strip that can realize an enhancement in sealing properties.

Hereinafter, means suitable for solving the problem will be described item by item. In addition, functions and advantages inherent in corresponding means will also be described additionally as required.

Means 1: A door weather strip attached round a peripheral portion of a door of a vehicle for producing a seal between a circumferential edge of a door opening and the door, including in at least part of an upper side portion thereof which is provided along an upper edge portion of the door:

an attaching base portion adapted to be fixed to an attaching surface formed on a door panel by fixing means;

a first seal portion adapted to be brought into press contact with the circumferential edge of the door opening when the door is closed;

a second seal portion adapted to be brought into press contact with the circumferential edge of the door opening in a position lying further transversely outwards than the position where the first seal portion is in press contact with the circumferential edge of the door opening;

a third seal portion adapted to be brought into press contact with a side wall surface of the door panel which is formed on an external side of the attaching surface in such a manner as to intersect the attaching surface;

a fourth seal portion formed in such a manner as to project from a side wall portion of the attaching base portion which is provided to face the side wall surface of the door panel and adapted to be brought into press contact with the side wall surface of the door panel in a position lying closer to the attaching surface than the position where the third seal portion is in press contact with the side wall surface of the door panel; and

a fifth seal portion formed in such a manner as to project from a base bottom portion of the attaching base portion which is provided to face the attaching surface of the door panel and adapted to be brought into press contact with the attaching surface in a position lying further transversely outwards than the fixing means, and wherein

a thickness of at least a connecting portion between the fifth seal portion and a main body portion of the base bottom portion is made thinner than a thickness of the main body portion of the base bottom portion.

According to Means 1 above, in the upper edge portion of the door, by the first and second seal portions being brought into press contact with the circumferential edge of the door opening and by the third to fifth seal portions being brought into press contact with the door panel, the door is fastened to the circumferential edge of the door opening tightly so as to produce a seal therebetween, whereby the prevention of ingress of rain water or the like into an interior of the vehicle is realized.

With respect to the press-contact relationship between the door weather strip and the door panel, even though there occurs an occasion when rain water or the like intrudes into the interior of the vehicle from a gap between the third seal portion and the door panel, the rain water or the like is prevented from intruding further inwards into the interior of the vehicle than the fourth seal portion by the fourth seal portion. In this means, since the fifth seal portion is provided further, a further enhancement in sealing properties is realized.

As a result, even when the door weather strip is fixed only by the fixing means such as the clips which are attached intermittently at predetermined intervals without using the relatively expensive pressure sensitive adhesive double coated tape in parallel, it becomes possible to ensure enough sealing properties to prevent the ingress of rain water or the like from the gap between the door weather strip and the door panel. Hence, by the omission of the pressure sensitive adhesive double coated tape, the simplification of the manufacturing process, reduction in processing time and suppression of increase in manufacturing costs can be realized.

In addition, a root portion of the projection-like fifth seal portion is formed thin and is hence easy to be deformed elastically, and compared with a configuration in which a bulk projecting portion is formed simply on the main body of the base bottom portion in such a manner as to project therefrom, good following properties to the door panel are provided. As a result, a difference in level produced at a welded portion formed, for example, on the door panel can be taken in, thereby making it possible to realize a further enhance in sealing properties.

In addition, the fourth seal portion is formed to project from the side wall portion of the attaching base portion. Because of this, compared, for example, with a case where the fourth seal portion is formed at an intermediate portion along the length of a tongue-shaped seal portion which is provided in such a manner as to extend from the attaching base portion, the fourth seal portion is made difficult to be affected by the first and second seal portions when they are brought into press contact with the circumferential edge of the door opening to thereby be deformed elastically. As a consequence, a defect that the fourth seal portion comes into press contact with the door opening's circumferential edge with its distal end portion folded or bent, or variation in press-contact position can be suppressed, whereby a partial seal break is made difficult to occur.

In addition, when the door is close, that is, when the door weather strip is brought into press contact with the circumferential edge of the door opening, since a load generated as a result of the press contact of the first and second seal portions with the circumferential edge of the door opening tends to easily escape transversely outwards, a load is made difficult to be applied which presses in a straight-line fashion the fifth seal portion against the attaching surface of the door panel. In this respect, according to this means, the load generated as a result of the press contact of the first and second seal portions with the circumferential edge of the door opening can be transmitted to the fifth seal portion via the supporting projecting portion. Because of this, the load is applied to the fifth seal portion from both internal and external sides thereof with good balance via the external side wall portion and the supporting projecting portion of the attaching base portion, so as to thrust the fifth seal portion against the attaching surface of the door panel in an appropriate fashion. As a result, a desired sealing pressure can be secured in a more ensured fashion when the door is closed, thereby making it possible to realize a further enhancement in sealing properties.

Means 2: The door weather strip according to Means 1, further comprising: a supporting projecting portion formed in such a manner as to project inwards from the base bottom portion of the attaching base portion in a position lying further transversely inwards than the fifth seal portion and adapted to be brought into press contact with an internal surface of the external side wall portion of the attaching base portion at least when the door is closed to thereby form a pseudo-hollow portion together with the base bottom portion and the external side wall portion of the attaching base portion.

In addition, only by providing simply a bulk portion from the base bottom portion to the external side wall portion of the attaching base portion with a view to facilitating the transmission of the load generated as a result of press contact deformation of the first and second seal portions to the fifth seal portion, rigidity is increased, leading to a fear that sealing properties are decreased. In contrast to this, according to this means, an elastic deformation is facilitated due to the pseudo-hollow portion being formed, and good following properties to the door panel are provided. As a result, a difference in level at a welded portion formed, for example, on the door panel can be taken in, thereby making it possible to realize a further enhancement in sealing properties.

In addition, as is seen from the fact that the pseudo-hollow portion is formed between the base bottom portion, external side wall portion and supporting projecting portion of the attaching base portion, the pseudo-hollow portion so formed is extremely smaller than a hollow portion of the first seal portion. Consequently, in a case where a genuine hollow portion is attempted to be provided in advance by the external side wall portion and the supporting projecting portion of the attaching base portion being extruded continuously in advance, there is caused a fear that at the time of extrusion of a door weather strip, the whole of the supporting projecting portion comes to stick to the external side wall portion, whereby the hollow portion is collapsed, and the intended hollow portion is not formed appropriately. Consequently, as according to this means, both the members are preferably formed spaced apart from each other in advance so that both the members are brought into press contact with each other at least when the door is closed.

Means 3: The door weather strip as set forth under Means 2, wherein the second seal portion is formed in such a manner as to project outwards from the external side wall portion of the attaching base portion, and wherein the supporting projecting portion is brought into press contact with a connecting portion between the second seal portion and the external side wall portion or the vicinity thereof.

According to Means 3, the load generated at the time of press-contact deformation from the second seal portion is made easy to be transmitted directly, thereby making it possible to enhance the function and advantage of Means 2 above.

Means 4: The door weather strip according to Means 2, wherein the fifth seal portion is formed substantially into a V shape in cross section, and the pseudo-hollow portion having a substantially rectangular sectional shape is formed when the supporting projecting portion is brought into press contact with the internal surface of the external side wall portion of the attaching base portion.

According to Means 4, when the supporting projection portion is in the press contact state, the periphery of the fifth seal portion is formed into a so-called pantograph shape. Consequently, compared with a case where the periphery of the fifth seal portion is formed such that the pseudo-hollow portion is formed into a substantially circular shape in cross section, the load is made to be applied easily towards the distal end of the fifth seal portion in an intense fashion. As a result, a further enhancement in following properties to the door panel or sealing properties can be realized.

In addition, with the fifth seal portion having the substantially V-shaped cross section, since there is no fear that the seal portion is brought into abutment with the door panel in such a state that the distal end portion is bent at the time of attachment, which would be the case with a tongue-shaped seal portion, a partial seal break is made difficult to happen.

Additionally, in the event that the fifth seal portion is tapered, the seal portion can be brought into press contact with the door panel with good efficiency in a line-contact state, whereby compared with a seal portion which is brought into press contact with the door panel in a surface-contact state, a further enhancement in sealing properties can be realized.

Means 5: The door weather strip according to Means 1, wherein the fifth seal portion is provided at an external end portion of the base bottom portion in a width direction thereof or in the vicinity thereof.

Load generated when the first and second seal portions are deformed as a result of their press contact with the door opening's circumferential edge tends to be easily applied to the external end portion of the base bottom portion in the width direction or to the vicinity thereof, compared with application of the load to the vicinity of a central portion of the base bottom portion in the width direction. Because of this, by adopting the configuration of Means 2 above, a desired sealing pressure can be secured in a more ensured fashion when the door is closed, thereby making it possible to realize a further enhancement in sealing properties.

Means 6: The door weather strip according to Means 1, wherein a thickness of a connecting portion between at least the fifth seal portion and a main body portion of the base bottom portion is made thinner than a thickness of the main body portion of the base bottom portion.

According to Means 6, a root portion of the projection-like fifth seal portion is formed thin and is hence easy to be deformed elastically, and compared with a configuration in which a bulk projecting portion is formed simply on the main body of the base bottom portion in such a manner as to project therefrom, good following properties to the door panel are provided. As a result, a difference in level produced at a welded portion formed, for example, on the door panel can be taken in, thereby making it possible to realize a further enhance in sealing properties.

Means 7: The door weather strip according to Means 1, wherein the fifth seal portion is formed into a V shape in cross section.

According to Means 7, since the fifth seal portion is made easier to be collapse deformed, increasing the following properties, a further increase in sealing properties can be realized. In addition, since the distal end is tapered, the fifth seal portion can be brought into press contact with the door panel with good efficiency in a line contact state, whereby compared with a seal portion which is brought into press contact with the door panel in a surface contact state, a further increase in sealing properties can be realized.

In addition, since the fifth seal portion according to Means 7 is free from a fear that it is brought into abutment with the door panel with its distal end portion folded or bent at the time of attachment, a partial seal break is made difficult to occur.

Means 8: The door weather strip according to Means 1, wherein at least the attaching base portion and the fifth seal portion are formed integrally of a sponge elastic material.

According to Means 8, an extremely labor-hour consuming process of attaching separately a sponge member as a fifth seal portion or two-color extruding an attaching base portion and a fifth seal portion from a solid elastic material and a sponge elastic material is not necessary, and hence, a simplification of manufacturing process can be realized, and an increase in manufacturing cost can be suppressed.

### BRIEF DESCRIPTION OF THE DRAWINGS

FIG. 1 is a perspective view showing an automotive vehicle in the embodiment 1.

FIG. 2 is a rear view showing a door in the embodiment 1.

FIG. 3 is a front view of a door weather strip in the embodiment 1.

FIG. 4 is a sectional view of the door weather strip taken along the line J-J in FIG. 3 in the embodiment 1.

FIG. 5 is an enlarged view showing a water stopping rib in the embodiment 1.

FIG. 6 is a partially enlarged view showing a water stopping rib according to another embodiment of the embodiment 1.

FIG. 7 is a perspective view showing an automotive vehicle in the embodiment 2.

FIG. 8 is a rear view showing a door in the embodiment 2.

FIG. 9 is a front view of a door weather strip in the embodiment 2.

FIG. 10 is a sectional view of the door weather strip taken along the line J-J in FIG. 9 in the embodiment 2.

FIG. 11 is a sectional view showing the door weather strip resulting when the door is closed.

FIG. 12 is a partial enlarged view showing a water stopping rib and a supporting projecting portion.

FIG. 13 is a partially enlarged view showing a water stopping rib according to another embodiment of the embodiment 2.

FIG. 14 is a partially enlarged view showing a water stopping rib according to a further embodiment of the embodiment 2.

FIG. 15 is a sectional view showing a door weather strip according to another embodiment of the embodiment 2.

### DESCRIPTION OF THE PREFERRED EMBODIMENTS

### Embodiment 1

Hereinafter, a first embodiment of a weather strip that is attached round an circumferential edge of a door of an automotive vehicle as a vehicle will be described by reference to the drawings.

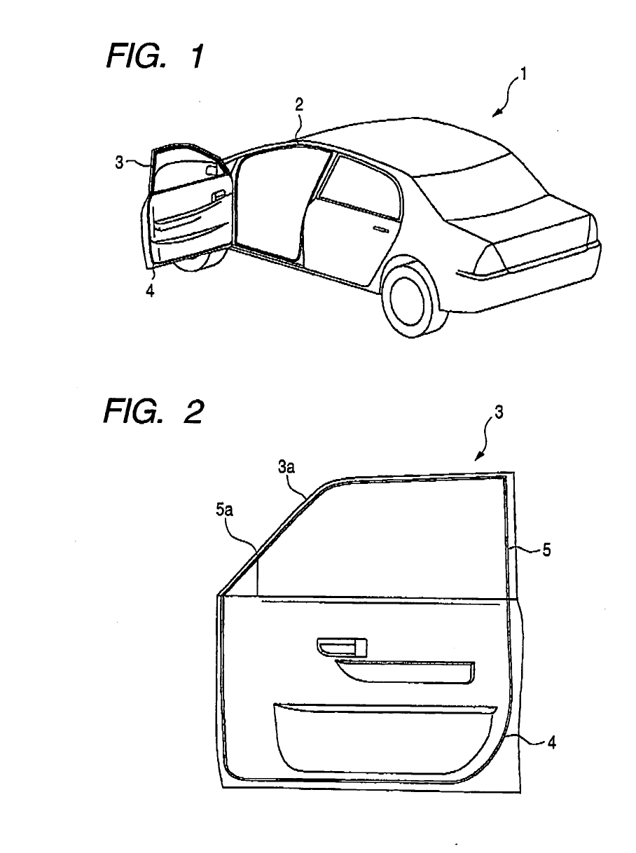

As is shown in FIGS. 1, 2, a door 3 is provided in a door opening 2 of an automotive vehicle 1 in such a manner as to be opened and closed, and a weather strip is attached round a circumferential edge of the door 3. In addition, the door 3 is made up of panels members such as an inner panel 5 and an outer panel 6 (refer to FIG. 4). Consequently, a door panel of this embodiment is made up of the panels 5, 6.

Of these panels, the inner panel 5 is formed by welding together panel members which has different thicknesses so as to have a difference in thickness on a hinge side (a left-hand side in FIG. 2) and an open side (a right-hand side in FIG. 2). This is because the thick panel member is used on the hinge side so as to ensure the rigidity on the hinge side. Because of this, a welded portion 5a is exposed at an upper edge portion 3a of the door 3.

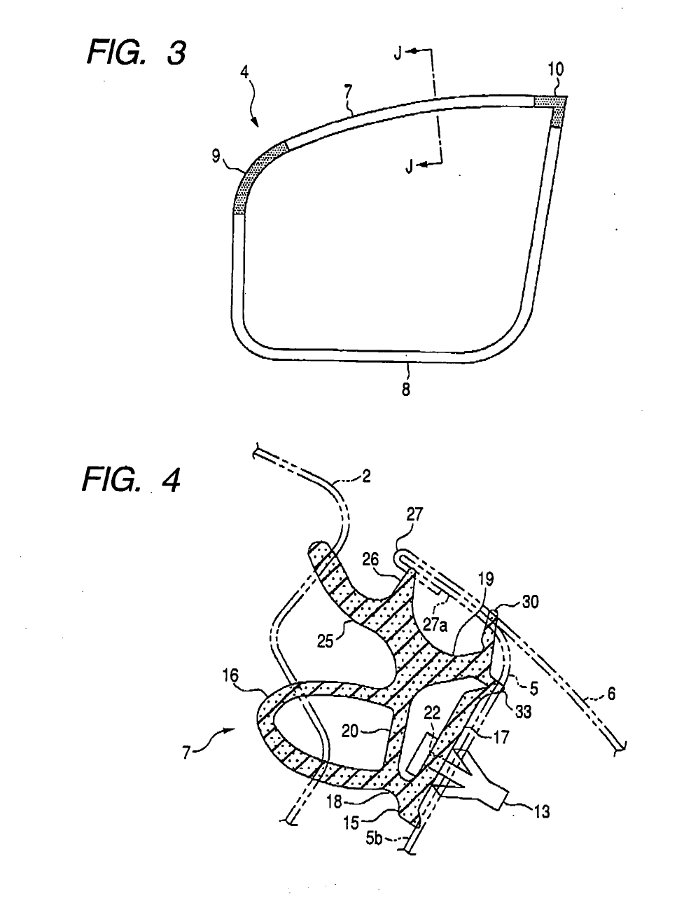

As is shown in FIG. 3, the door weather strip is made into an annular shape from EPDM (ethylene-propylene-diene terpolymer) sponge rubber as a sponge elastic material (a rubber material) in such a manner as to extend along the circumferential edge of the door 3. In addition, an EPDM sponge rubber having a specific weight of 0.4 to 0.7 is adopted as the EPDM sponge rubber of the embodiment.

The door weather strip 4 includes extruded portions 7, 8 and molded portions (portions shaded with scattered dots in the figure) 9, 10. The extruded portions 7, 8 are formed substantially in a straight line (into an elongated shape) by an extruding machine, not shown. In addition, the molded portions 9, 10 are molded by a predetermined molding machine in such a manner as to be connected with ends of the extruded portions 7, 8.

As is shown in FIG. 4, which is a sectional view taken along the line J-J in FIG. 3, the door weather strip 4 of the embodiment is designed to be attached to the door 3 having a construction in which fitting portions such as retainers are not provided along the circumferential edge of the door. Thus, the door weather strip 4 is attached to an attaching surface 5b formed on the inner panel 5 with clips 13 as fixing means.

Furthermore, the extruded portion 7 of the door weather strip 4 which makes up mainly an upper side portion provided along the upper edge portion 3a of the door has a construction which can ensure enough sealing properties to prevent the ingress of rain water or the like into an interior of the vehicle without using a pressure sensitive adhesive double coated tape.

Here, taking its characteristic portions into consideration, the extruded portion 7 will be described in detail. The extruded portion 7 includes an attaching base portion 15 adapted to be fixed to the attaching surface 5b f the inner panel 5 and a hollow main seal portion 16 having a hollow portion in an interior thereof and adapted to be brought into press contact with a peripheral portion of the door opening 2 when the door 3 is closed. In this embodiment, the main seal portion 16 corresponds to the first seal portion.

The attaching base portion 15 is made up of a base bottom portion 17 which is provided in such a manner as to extend along the attaching surface 5b of the inner panel 5, as well as an internal side wall portion 18 and an external side wall portion 19 which are formed in such a manner as to project from the bottom base portion 17. Then, the main seal portion 16 is formed in such a manner as to extend from distal end portions of both the side wall portions 18, 19, and a bridge portion 20 is also formed in the same way to partition the hollow portion inside the main seal portion 16.

Clip attaching holes 22 are formed on the base bottom portion 17 at predetermined intervals along a longitudinal direction of the extruded portion 7, whereby clip members 13 are attached via the clip attaching holes 22.

In addition, a sub-seal lip 25 is formed in such a manner as to extend to the outside of the vehicle or transversely outwards from the external side wall portion 19 of the attaching base portion 15. The sub-seal lip 15 is brought into press contact with the circumferential edge of the door opening 2 in a position lying further transversely outwards than the position where the main seat portion 16 is in press contact with the circumferential edge of the door opening 2. In this embodiment, the sub-seal lip 25 corresponds to the second seal portion.

Furthermore, a back-side lip 26 is formed in such a manner as to extend transversely outwards from a substantially central portion in the extending direction of the sub-seal lip 25. The back-side lip 26 is brought into press contact with a flange portion 27 which is made up of the inner panel 5 and the outer panel 6. In addition, the flange portion 27 is formed integrally by bending an external edge portion of the inner panel 5 in such a manner as to intersect the attaching surface 5b, superposing the outer panel 6 on an external side of the bent portion in question, and folding back the edge portion for application of hemming work thereto. Consequently, in this embodiment, an external side surface 27a of the flange portion 27 corresponds to the side wall surface of the door panel, and the back-side lip 26 corresponds to the third seal portion.

A draining lip 30 is formed on the external side wall portion 10 of the attaching base portion 15 in the vicinity of a connecting portion with the base bottom portion 17 in such a manner as to extend transversely outwards. The draining lip 30 is brought into press contact with the flange portion 27 in a position lying closer to the attaching surface 5b of the inner panel 5 than the position where the back-side lip is in press contact with the flange portion 27. In this embodiment, this draining lip 30 corresponds to the fourth seal portion.

In addition, a water stopping rib 33 is formed on the base bottom portion 17 of the attaching base portion 15 at an external end portion thereof in the width direction, that is, in a connecting point with the external side wall portion 19. The water stopping rib 33 is brought into press contact with the attaching surface 5b of the inner panel 5. In this embodiment, the water stopping rib 33 corresponds to the fifth seal portion.

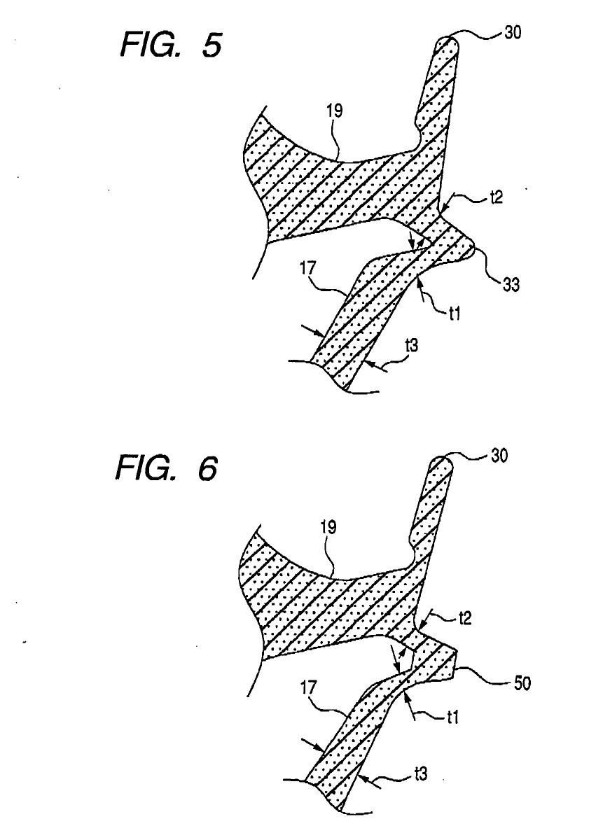

As is shown in FIG. 5, the water stopping rib 33 has a V-shaped cross-sectional shape in which the water stopping rib 33 is made to project outwards of the base bottom portion 17, both a thickness t1 at its internal connecting portion and a thickness t2 at an external connecting portion are made thinner than a thickness t3 of the main body of the base bottom portion 17.

In addition, although its illustration is omitted, the extruded portion 8 has a sectional shape which is slightly different from that of the extruded portion 7 and includes as attaching base portion 15 and a main seal portion 16. However, the extruded portion 8 does not include the back-side lip 26, the draining lip 30, the water stopping rib 33 and the like. This is because in a vertical edge portion of the door 3, rain water or the like flows downwards and hence, there is caused no fear that rain water or the like intrudes into the interior of the vehicle.

Additionally, the molded portions 9, 10 which connect the extruded portions 7, 8 together each include a sub-seal lip 25 and a back-side lip 26 in a portion which is provided on the upper edge portion 3a of the door 3 in such a manner as to be continuous to the extruded portion 7. However, neither draining lip 33 nor water stopping rib 33 is provided thereon because it is believed to be sufficient in the event that they are provided only on the extruded portion. Of course, in the event a draining lip 30 and a water stopping rib 33 are provided on the molded portions 9, 10, a further increase in sealing properties can be realized.

As has been described in detail above, by the main seal portion 16 and the sub-seal lip 25 being brought into press contact with the circumferential edge of the door opening 2 and the back-side lip 26, the draining lip 30 and the water stopping rib 33 being brought into press contact with the door 3 at the upper edge portion 3a (the extruded portion 7) of the door 3 when the door 3 is closed, the door 3 is fastened tightly to the circumferential edge of the door opening 2 to thereby produce a seal therebetween, whereby the ingress of rain water or the like into the interior of the vehicle is realized.

With respect to the press-contact relationship between the door weather strip 4 and the door 3, even though there occurs an occasion when rain water or the like intrudes into the interior of the vehicle from a gap between the back-side lip 26 and the flange portion 27, the rain water or the like is prevented from intruding further inwards into the interior of the vehicle than the raining lip 30 by the draining lip 30. In this embodiment, since the water stopping rib 33 is provided further, a further enhancement in sealing properties is realized.

As a result, even when the door weather strip 4 is fixed only by the clips 13 which are attached intermittently at the predetermined intervals without using the relatively expensive pressure sensitive adhesive double coated tape in parallel, it becomes possible to ensure enough sealing properties to prevent the ingress of rain water or the like from the gap between the door weather strip 4 and the door 3. Hence, by the omission of the pressure sensitive adhesive double coated tape, the simplification of the manufacturing process, reduction in processing time and suppression of increase in manufacturing costs can be realized.

The water stopping rib 33 of this embodiment is made thinner than the thickness t3 of the main body of the base bottom portion 17 so as to be easily deformed in an elastic fashion, compared with a configuration in which a bulk projecting portion is formed simply on the main body of the base bottom portion 17 in such a manner as to project therefrom, and good following properties to the inner panel 5 are provided. As a result, a difference in level produced at a welded portion formed, for example, on the inner panel 5 can be taken in, thereby making it possible to realize a further enhance in sealing properties.

Furthermore, the water stopping rib 33 is formed into the V shape in cross section. Consequently, the water stopping rib 33 is made easy to be collapsed, and the following properties are increased, whereby a further increase in sealing properties can be realized. In addition, since the distal end is tapered, the water stopping rib 33 can be brought into press contact with the inner panel with good efficiency in a line-contact state. By this configuration, compared with a case where a seal portion is brought into press contact with a panel in a surface-contact state, a further enhancement in sealing properties can be realized. In addition, as with a tongue-shaped seal portion, since there is no fear that the water stopping rib 33 is brought into abutment with the inner panel 5 with its distal end portion folded or bent at the time of attachment, a partial seal break is also made difficult to occur.

In addition, since the draining lip 30 is formed in such a manner as to project from the external side wall portion 19 of the attaching base portion 15, compared, for example, with a case where it is formed at an intermediate portion along the length of the sub-seal lip 25, the draining lip 30 is made difficult to be affected by the main seal portion 16 and the sub-seal lip 25 when they are deformed as a result of press contact with the circumferential edge of the door opening 2. As a result, a defect that the draining lip 30 is brought into press contact with the inner panel 5 with its distal end portion folded or bent or variation in press contact position can be suppressed, whereby a partial seal break is made difficult to occur.

Furthermore, the entirety of the door weather strip 4 including the attaching base portion 15 and the water stopping rib 33 is formed from an EPDM sponge rubber. Because of this, an extremely labor-hour consuming process of attaching separately a sponge member as the water stopping rib or two-color extruding an attaching base portion 15 and a water stopping rib 33 from a solid elastic material and a sponge elastic material is not necessary, and hence, a simplification of manufacturing process can be realized, and an increase in manufacturing cost can be suppressed.

As is seen by looking at FIG. 4, as its sealing form, the extruded portion 7 takes a bending type in which the main seal portion 16 is brought into press contact with the circumferential edge of the door opening 2 in such a state that the main seal portion 16 is tilted transversely outwards when the door 3 is closed. In the case of this bending type, a load generated when the main seal portion 16 and the sub-seal lip 25 are deformed as a result of press contact with the circumferential edge of the door opening 2 tends to be easily applied to an external end portion of the base bottom portion 17 in the width direction which constitutes the connecting portion with the external side wall portion 19 of the attaching base portion 15, compared with application of the same load to the vicinity of a central portion of the base bottom portion 17 in the width direction. Because of this, by the water stopping rib 33 being attached to the position described in the embodiment, a desired sealing pressure can be secured in a more ensured fashion when the door 3 is closed, thereby making it possible to realize a further enhancement in sealing properties.

Note that the invention is not limited to the contents of the embodiment described heretofore, and hence may be carried out as below. Of course, other application examples and modified examples than those which will be described below can, needless to say, be adopted.

(a) In the embodiment, while the invention is embodied into the door weather strip 4 which is attached round the circumferential edge of the front side door 3, the invention can also be applied to a door weather strip which is attached round a circumferential edge portion of other doors including a rear door.

(b) While the door weather strip 4 of the embodiment is of the annular type in which the door weather strip 4 is attached round the full circumference of the circumferential edge of the door 3, the door weather strip 4 does not always have to take the annular shape, and hence, a door weather strip 4 may be adopted which is designed to be attached partially to at least a portion of the door which includes the upper edge portion 3a of the door 3.

(c) In the embodiment, while the EPDM rubber is adopted as the material (elastic material) of the door weather strip 4, the door weather strip 4 may be made, in addition thereto, from other elastic materials having rubber-like elasticity such as various types of rubber materials including styrene butadiene rubber, butadiene rubber, chloropropylene rubber, butyl rubber, nytril rubber, ethylene-propylene copolymer rubber, and acryl rubber or olefin-based thermoplastic elastomer (TPO) or a soft polyvinyl chloride.

In addition, while the entirety of the door weather strip 4 including the attaching base portion 15 and the water stopping rib 33 of the embodiment is formed from the EPDM sponge rubber, the invention is not limited thereto, and hence, a configuration may be adopted in which only part of the door weather strip 4 such as, for example, the main seal portion 16 and the sub-seal lip 25 is formed from the sponge elastic material. However, the water stopping rib 33 is preferably made from the sponge elastic material in order to obtain the function and advantage thereof that have been described in the embodiment.

(d) In the embodiment, while the clip members 13 are adopted as the fixing means for fixing the door weather strip 4, the invention is not limited thereto, and hence, a configuration may be adopted in which the door weather strip 4 is fixed intermittently or partially by a pressure sensitive adhesive double coated tape or an adhesive.

(e) In the embodiment, the water stopping rib 33 is provided at the external end portion in the width direction of the base bottom portion 17 of the attaching base portion 15. The position where the water stopping rib 33 is provided is not limited thereto, and hence, any position may be adopted, provided that the position lies further transversely outwards than at least the clip members 13. However, in consideration of the fact that the load tends to be easily applied to the external end portion of the base bottom portion 17 in the width direction which constitutes the connecting portion with the external side wall portion 19 of the attaching base portion 15 or the vicinity thereof when the door 3 is closed, the water stopping rib 33 is preferably provided at the external end portion of the base bottom portion 17 in the width direction or the vicinity thereof.

(f) In the embodiment, the water stopping rib 33 is formed into the V shape in cross section. The invention is not limited thereto, and as is shown, for example, in FIG. 6, a water stopping rib 50 may be adopted in which the water rib 50 is formed into a trapezoidal shape in cross section with a distal end portion made flat. Of course, also in this case, a thickness t1 of an internal connecting portion with a main body of a base bottom portion 17 and a thickness t2 of an external connecting portion are both made thinner than a thickness of the main body of the base bottom portion 17.

(g) The sectional shape of the door weather strip 4 is not limited to that described in the embodiment. For example, a configuration may be adopted in which the bridge portion 20 or the like is omitted.

### Embodiment 2

Hereinafter, a second embodiment of a weather strip that is attached round an circumferential edge of a door of an automotive vehicle as a vehicle will be described by reference to the drawings.

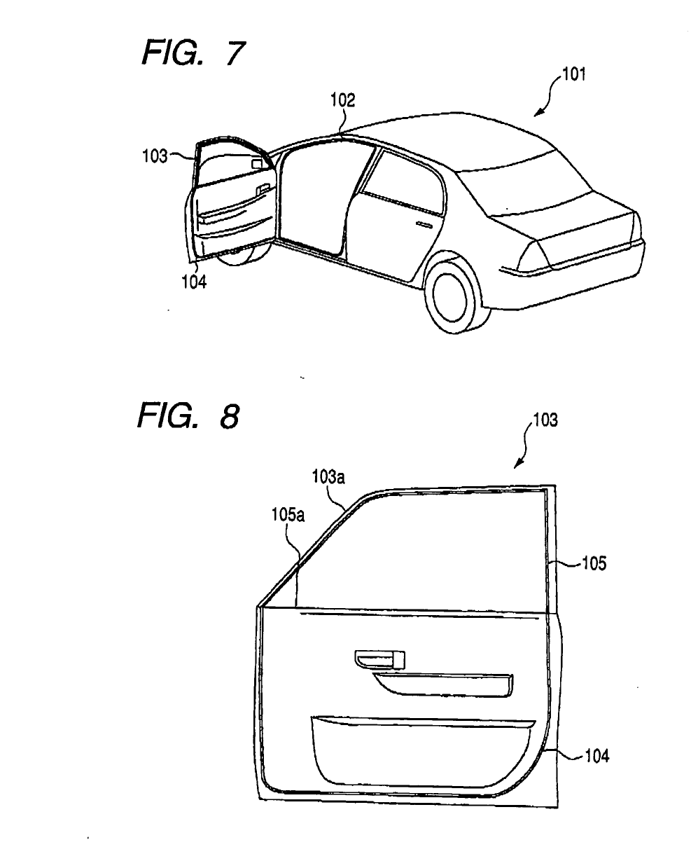

As is shown in FIGS. 7, 8, a door 103 is provided in a door opening 102 of an automotive vehicle 101 in such a manner as to be opened and closed, and a weather strip is attached round a circumferential edge of the door 103. In addition, the door 103 is made up of panels members such as an inner panel 105 and an outer panel 106 (refer to FIG. 10). Consequently, a door panel of this embodiment is made up of the panels 105, 106.

Of these panels, the inner panel 105 is formed by welding together panel members which has different thicknesses so as to have a difference in thickness on a hinge side (a left-hand side in FIG. 8) and an open side (a right-hand side in FIG. 8). This is because the thick panel member is used on the hinge side so as to ensure the rigidity on the hinge side. Because of this, a welded portion 105a is exposed at an upper edge portion 103a of the door 103.

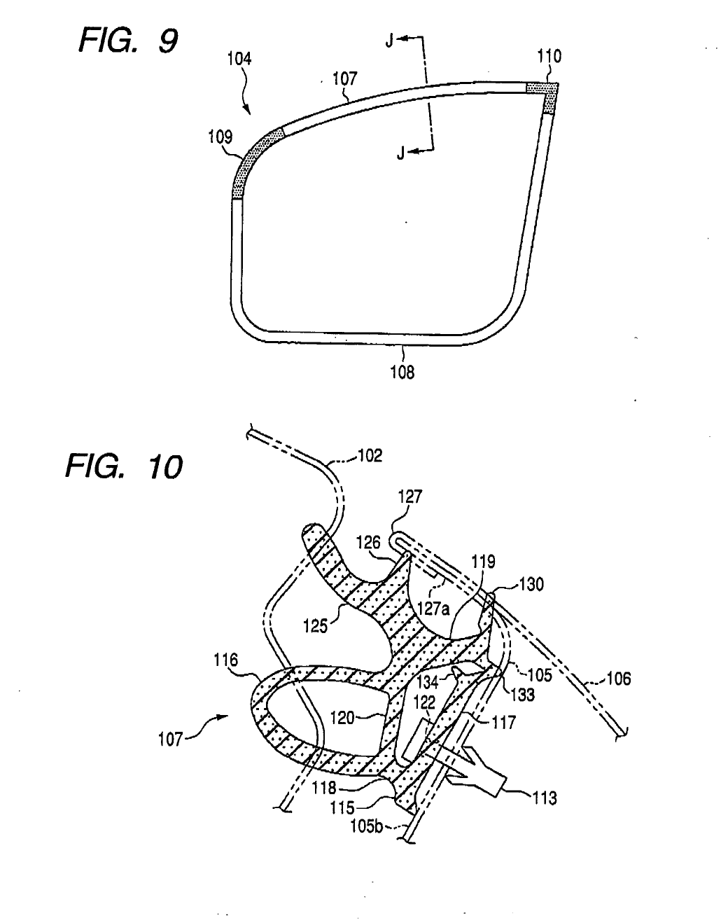

As is shown in FIG. 9, the door weather strip is made into an annular shape from EPDM (ethylene-propylene-diene terpolymer) sponge rubber as a sponge elastic material (a rubber material) in such a manner as to extend along the circumferential edge of the door 103. In addition, an EPDM sponge rubber having a specific weight of 0.4 to 0.7 is adopted as the EPDM sponge rubber of the embodiment.

The door weather strip 104 includes extruded portions 107, 108 and molded portions (portions shaded with scattered dots in the figure) 109, 110. The extruded portions 107, 108 are formed substantially in a straight line (into an elongated shape) by an extruding machine, not shown. In addition, the molded portions 109, 110 are molded by a predetermined molding machine in such a manner as to be connected with ends of the extruded portions 107, 108.

As is shown in FIG. 10, which is a sectional view taken along the line J-J in FIG. 9, the door weather strip 104 of the embodiment is designed to be attached to the door 103 having a construction in which fitting portions such as retainers are not provided along the circumferential edge of the door. Thus, the door weather strip 104 is attached to an attaching surface 105b formed on the inner panel 105 with clips 113 as fixing means.

Furthermore, the extruded portion 107 of the door weather strip 104 which makes up mainly an upper side portion provided along the upper edge portion 103a of the door has a construction which can ensure enough sealing properties to prevent the ingress of rain water or the like into an interior of the vehicle without using a pressure sensitive adhesive double coated tape.

Here, taking its characteristic portions into consideration, the extruded portion 107 will be described in detail. The extruded portion 107 includes an attaching base portion 115 adapted to be fixed to the attaching surface 105b f the inner panel 105 and a hollow main seal portion 116 having a hollow portion in an interior thereof and adapted to be brought into press contact with a circumferential edge of the door opening 102 when the door 103 is closed. In this embodiment, the main seal portion 116 corresponds to the first seal portion.

The attaching base portion 115 is made up of a base bottom portion 117 which is provided in such a manner as to extend along the attaching surface 105b of the inner panel 105, as well as an internal side wall portion 118 and an external side wall portion 119 which are formed in such a manner as to project from the bottom base portion 117. Then, the main seal portion 116 is formed in such a manner as to extend from distal end portions of both the side wall portions 118, 119, and a bridge portion 120 is also formed in the same way to partition the hollow portion inside the main seal portion 116.

Clip attaching holes 122 are formed on the base bottom portion 117 at predetermined intervals along a longitudinal direction of the extruded portion 107, whereby clip members 113 are attached via the clip attaching holes 122.

In addition, a sub-seal lip 125 is formed in such a manner as to extend to the outside of the vehicle or transversely outwards from the external side wall portion 119 of the attaching base portion 115 The sub-seal lip 125 is brought into press contact with the circumferential edge of the door opening 102 in a position lying further transversely outwards than the position where the main seal portion 116 is in press contact with the circumferential edge of the door opening 102. In this embodiment, the sub-seal lip 125 corresponds to the second seal portion.

Furthermore, a back-side lip 126 is formed in such a manner as to extend transversely outwards from a substantially central portion in the extending direction of the sub-seal lip 125. The back-side lip 126 is brought into press contact with a flange portion 127 which is made up of the inner panel 105 and the outer panel 106. In addition, the flange portion 127 is formed integrally by bending an external edge portion of the inner panel 105 in such a manner as to intersect the attaching surface 105b, superposing the outer panel 106 on an external side of the bent portion in question, and folding back the edge portion for application of hemming work thereto. Consequently, in this embodiment, an external side surface 127a of the flange portion 127 corresponds to the side wall surface of the door panel, and the back-side lip 126 corresponds to the third seal portion.

A draining lip 130 is formed on the external side wall portion 110 of the attaching base portion 115 in the vicinity of a connecting portion with the base bottom portion 117 in such a manner as to extend transversely outwards. The draining lip 130 is brought into press contact with the flange portion 127 in a position lying closer to the attaching surface 105b of the inner panel 105 than the position where the back-side lip is in press contact with the flange portion 127. In this embodiment, this draining lip 130 corresponds to the fourth seal portion.

In addition, a water stopping rib 133 is formed on the base bottom portion 117 of the attaching base portion 115 at an external end portion thereof in the width direction, that is, in a connecting point with the external side wall portion 119. The water stopping rib 133 is brought into press contact with the attaching surface 105b of the inner panel 105. In this embodiment, the water stopping rib 133 corresponds to the fifth seal portion.

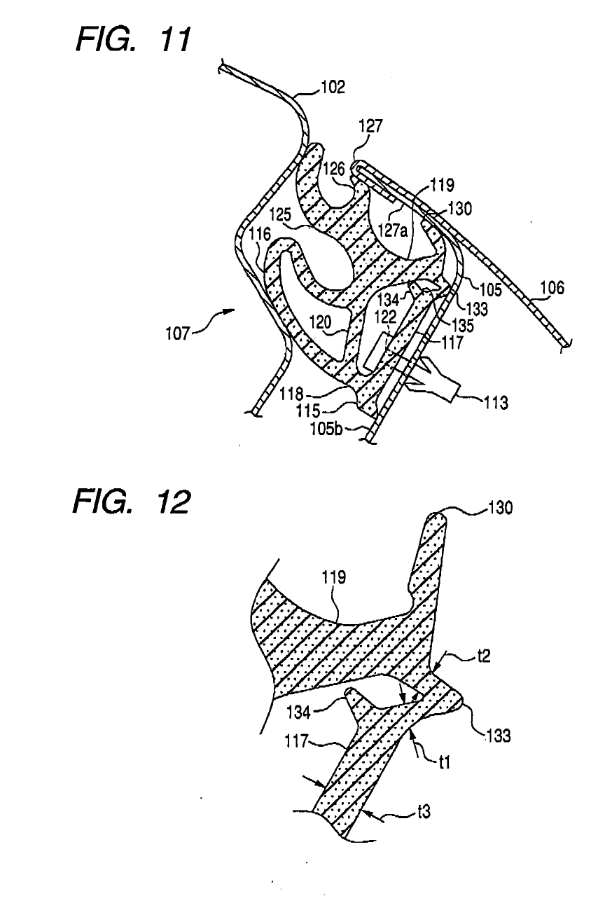

In addition, a supporting projecting portion 134 is formed on the base bottom portion 117 of the attaching base portion 115 in such a manner as to project towards the main seal portion 116 side, that is, inwards in a position lying further transversely inwards than the water stopping rib 133. As is shown in FIG. 11, the supporting projecting portion 134 is brought into press contact with an internal surface of the external side wall portion 119 of the attaching base portion 115 in the vicinity of the root portion of the sub-seal lip 125 at least when the door 103 is closed, whereby a pseudo-hollow portion 135 is formed between the base bottom portion 117 and the external side wall portion 119 of the attaching base portion 115.

In addition, as is shown in FIG. 12, the water stopping rib 133 has a V-shaped cross-sectional shape in which the water stopping rib 133 is made to project outwards of the base bottom portion 117, both a thickness t1 at its internal connecting portion and a thickness t2 at an external connecting portion are made thinner than a thickness t3 of the main body of the base bottom portion 117, whereby when the supporting projecting portion 134 is brought into press contact with the internal surface of the external side wall portion 119 of the attaching base portion 115 to thereby form the pseudo-hollow portion 135, the pseudo-hollow portion 135 is then formed into a substantially rectangular in section, whereby the periphery of the water stopping rib 133 is formed into the so-called pantograph shape (refer to FIG. 11).

In addition, although its illustration is omitted, the extruded portion 108 has a sectional shape which is slightly different from that of the extruded portion 107 and includes as attaching base portion 115 and a main seal portion 116. However, the extruded portion 108 does not include the back-side lip 126, the draining lip 130, the water stopping rib 133 and the like. This is because in a vertical edge portion of the door 103, rain water or the like flows downwards and hence, there is caused no fear that rain water or the like intrudes into the interior of the vehicle.

Additionally, the molded portions 109, 110 which connect the extruded portions 107, 108 together each include a sub-seal lip 125 and a back-side lip 126 in a portion which is provided on the upper edge portion 103a of the door 103 in such a manner as to be continuous to the extruded portion 107. However, the draining lip 133, the water stopping rib 133 and the supporting projecting portion 134 are not provided thereon because it is believed to be sufficient in the event that they are provided only on the extruded portion. Of course, in the event a draining lip 130, a water stopping rib 133 and a supporting projecting portion 134 are provided on the molded portions 109, 110, a further increase in sealing properties can be realized.

As has been described in detail above, by the main seal portion 116 and the sub-seal lip 125 being brought into press contact with the circumferential edge of the door opening 102 and the back-side lip 126, the draining lip 130 and the water stopping rib 133 being brought into press contact with the door 103 at the upper edge portion 103a (the extruded portion 107) of the door 103 when the door 103 is closed, the door 103 is fastened tightly to the circumferential edge of the door opening 102 to thereby produce a seal therebetween, whereby the ingress of rain water or the like into the interior of the vehicle is realized.

With respect to the press-contact relationship between the door weather strip 104 and the door 103, even though there occurs an occasion when rain water or the like intrudes into the interior of the vehicle from a gap between the back-side lip 126 and the flange portion 127, the rain water or the like is prevented from intruding further inwards into the interior of the vehicle than the raining lip 130 by the draining lip 130. In this embodiment, since the water stopping rib 133 is provided further, a further enhancement in sealing properties is realized.

As a result, even when the door weather strip 104 is fixed only by the clips 113 which are attached intermittently at the predetermined intervals without using the relatively expensive pressure sensitive adhesive double coated tape in parallel, it becomes possible to ensure enough sealing properties to prevent the ingress of rain water or the like from the gap between the door weather strip 104 and the door 103. Hence, by the omission of the pressure sensitive adhesive double coated tape, the simplification of the manufacturing process, reduction in processing time and suppression of increase in manufacturing costs can be realized.

As is seen by looking at FIG. 11, as its sealing form, the extruded portion 107 takes a bending type in which the main seal portion 116 is brought into press contact with the circumferential edge of the door opening 102 in such a state that the main seal portion 116 is tilted transversely outwards when the door 103 is closed. In the case of this bending type, since a load generated as a result of the press contact of the main seal portion 116 and the sub-seal portion with the circumferential edge of the door opening 102 tends to easily escape transversely outwards, a load is made difficult to be applied which presses in a straight-line fashion the water stopping rib 133 against the attaching surface 105a of the inner panel 105. In this respect, according to the embodiment, the load generated as a result of the press contact of the main seal portion 116 and the sub-seal lip 125 with the circumferential edge of the door opening 102 can be transmitted to the water stopping rib 133 via the supporting projecting portion 134. Because of this, the load is applied to the water stopping rib 133 from both internal and external sides thereof with good balance via the external side wall portion 119 and the supporting projecting portion 134 of the attaching base portion 115, so as to thrust the water stopping rib 133 against the attaching surface 105b of the inner panel 105 in an appropriate fashion. As a result, a desired sealing pressure can be secured in a more ensured fashion when the door is closed, thereby making it possible to realize a further enhancement in sealing properties.

In addition, the supporting projecting portion 134 is brought into press contact with the internal surface of the external side wall portion 119 of the attaching base portion 115 in the vicinity of the root portion of the sub-seal lip 125. Because of this, the load generated at the time of press contact deformation is made easy to be transmitted directly from the sub-seal lip 125, whereby the above function and advantage can be enhanced further.

As is seen from what has been described above, the load generated at the time of press contact deformation of the main seal portion 116 and the sub-seal portion 125 is made easy to be applied to an external end portion of the base bottom portion 117 in the width direction which constitutes the connecting portion with the external side wall portion 119 of the attaching base portion 115, compared with application of the same load to the vicinity of a central portion of the base bottom portion 117 in the width direction. Because of this, by the water stopping rib 133 being attached to the position described in the embodiment, a desired sealing pressure can be secured in a more ensured fashion when the door 103 is closed, thereby making it possible to realize a further enhancement in sealing properties.

In addition, only by providing simply a bulk portion from the base bottom portion 117 to the external side wall portion 119 of the attaching base portion 115 with a view to facilitating the transmission of the load generated as a result of press contact deformation of the main seal portion 116 and the sub-seal portion 125 to the water stopping rib 133, rigidity is increased, leading to a fear that sealing properties are decreased. In contrast to this, according to the embodiment, an elastic deformation is facilitated due to the pseudo-hollow portion 135 being formed, and good following properties to the door panel 105 are provided. In addition, the water stopping rib 133 of this embodiment is made thinner than the thickness t3 of the base bottom portion 117 and is hence made easy to be deformed elastically compared with a case where a bulk projecting portion is simply formed in such a manner as to project from the main body of the base bottom portion 117, whereby the good following properties to the inner panel 105 are provided. As a result, a difference in level at the welded portion 105a formed, for example, on the inner panel 105 can be taken in, thereby making it possible to realize a further enhancement in sealing properties.

In addition, as is seen from the fact that the pseudo-hollow portion 135 is formed between the base bottom portion 117, external side wall portion 119 and supporting projecting portion 134 of the attaching base portion 115, the pseudo-hollow portion 135 so formed is extremely smaller than a hollow portion of the main seal portion 116 (refer to FIG. 11). Consequently, in a case where a genuine hollow portion is attempted to be provided in advance by the external side wall portion 119 and the supporting projecting portion 134 of the attaching base portion 115 being extruded continuously in advance, there is caused a fear that at the time of extrusion of a door weather strip, the whole of the supporting projecting portion 134 comes to stick to the external side wall portion 119, whereby the hollow portion is collapsed, and the intended hollow portion is not formed appropriately. Consequently, as according to this means, both the members are preferably formed spaced apart from each other in advance so that both the members are brought into press contact with each other at least when the door 103 is closed.

Furthermore, the water stopping rib 133 is formed into the V shape in cross section. Consequently, the water stopping rib 133 is made easy to be collapsed, and the following properties are increased, whereby a further increase in sealing properties can be realized. In addition, since the distal end is tapered, the water stopping rib 133 can be brought into press contact with the inner panel with good efficiency in a line-contact state. By this configuration, compared with a case where a seal portion is brought into press contact with a panel in a surface-contact state, a further enhancement in sealing properties can be realized. In addition, as with a tongue-shaped seal portion, since there is no fear that the water stopping rib 133 is brought into abutment with the inner panel 105 with its distal end portion folded or bent at the time of attachment, a partial seal break is also made difficult to occur.

In addition, when the supporting projecting portion 134 is in press contact with the internal surface of the external side wall portion 119, the pseudo-hollow portion 135 is formed between the base bottom portion 117 and the external side wall portion 119 of the attaching base portion 115, whereby the periphery of the water stopping rib 133 is formed into the so-called pantograph shape. Consequently, compared with a case where the periphery of the water stopping rib 133 is formed such that the pseudo-hollow portion 135 is formed into a substantially circular shape in cross section, the load is made to be applied easily towards the distal end of the water stopping rib 133 in an intense fashion. As a result, a further enhancement in following properties to the inner panel 105 or sealing properties can be realized.

On the other hand, since the draining lip 130 is formed in such a manner as to project from the external side wall portion 119 of the attaching base portion 115, compared, for example, with a case where it is formed at an intermediate portion along the length of the sub-seal lip 125, the draining lip 130 is made difficult to be affected by the main seal portion 116 and the sub-seal lip 125 when they are deformed as a result of press contact with the circumferential edge of the door opening 102. As a result, a defect that the draining lip 130 is brought into press contact with the inner panel 105 with its distal end portion folded or bent or variation in press contact position can be suppressed, whereby a partial seal break is made difficult to occur.

Furthermore, the entirety of the door weather strip 104 including the attaching base portion 115, the water stopping rib 133 and the supporting projecting portion 134 is formed from an EPDM sponge rubber. Because of this, an extremely labor-hour consuming process of attaching separately a sponge member as the water stopping rib or two-color extruding an attaching base portion 115, a water stopping rib 133 and a supporting projecting portion 134 from a solid elastic material and a sponge elastic material is not necessary, and hence, a simplification of manufacturing process can be realized, and an increase in manufacturing cost can be suppressed.

Note that the invention is not limited to the contents of the embodiment described heretofore, and hence may be carried out as below. Of course, other application examples and modified examples than those which will be described below can, needless to say, be adopted.

(a) In the embodiment, while the invention is embodied into the door weather strip 104 which is attached round the circumferential edge of the front side door 103, the invention can also be applied to a door weather strip which is attached round a circumferential edge portion of other doors including a rear door.

(b) While the door weather strip 104 of the embodiment is of the annular type in which the door weather strip 104 is attached round the full circumference of the circumferential edge of the door 3, the door weather strip 104 does not always have to take the annular shape, and hence, a door weather strip 104 may be adopted which is designed to be attached partially to at least a portion of the door which includes the upper edge portion 103a of the door 103.

(c) In the embodiment, while the EPDM rubber is adopted as the material (elastic material) of the door weather strip 104, the door weather strip 104 may be made, in addition thereto, from other elastic materials having rubber-like elasticity such as various types of rubber materials including styrene butadiene rubber, butadiene rubber, chloropropylene rubber, butyl rubber, nytril rubber, ethylene-propylene copolymer rubber, and acryl rubber or olefin-based thermoplastic elastomer (TPO) or a soft polyvinyl chloride.

In addition, while the entirety of the door weather strip 104 including the attaching base portion 115 and the water stopping rib 133 of the embodiment is formed from the EPDM sponge rubber, the invention is not limited thereto, and hence, a configuration may be adopted in which only part of the door weather strip 104 such as, for example, the main seal portion 116 and the sub-seal lip 125 is formed from the sponge elastic material. However, the water stopping rib 133 is preferably made from the sponge elastic material in order to obtain the function and advantage thereof that have been described in the embodiment.

(d) In the embodiment, while the clip members 113 are adopted as the fixing means for fixing the door weather strip 104, the invention is not limited thereto, and hence, a configuration may be adopted in which the door weather strip 104 is fixed intermittently or partially by a pressure sensitive adhesive double coated tape or an adhesive.

(e) In the embodiment, the water stopping rib 133 is provided at the external end portion in the width direction of the base bottom portion 117 of the attaching base portion 115. The position where the water stopping rib 133 is provided is not limited thereto, and hence, any position may be adopted, provided that the position lies further transversely outwards than at least the clip members 113. However, in consideration of the fact that the load tends to be easily applied to the external end portion of the base bottom portion 117 in the width direction which constitutes the connecting portion with the external side wall portion 119 of the attaching base portion 115 or the vicinity thereof when the door 103 is closed, the water stopping rib 133 is preferably provided at the external end portion of the base bottom portion 117 in the width direction or the vicinity thereof.

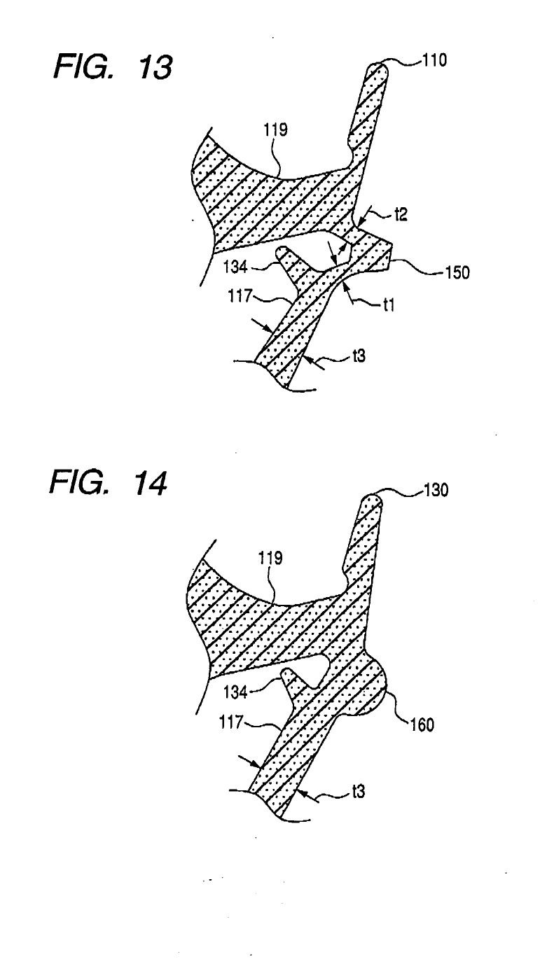

(f) In the embodiment, the water stopping rib 133 is tapered to be formed into the V shape in cross section. The invention is not is limited thereto, and as is shown, for example, in FIG. 13, a water stopping rib 150 may be adopted in which the water rib 150 is formed into a trapezoidal shape in cross section with a distal end portion made flat. Also in the case of this example, a thickness t1 of an internal connecting portion with a main body of a base bottom portion 117 and a thickness t2 of an external connecting portion are both made thinner than a thickness of the main body of the base bottom portion 117. In contrast to this, as is shown in FIG. 14, a swelling water stopping rib 160 which is formed in such a manner as to project from the base bottom portion 117 may be adopted without the connecting portion being made thinner than the thickness t3 of the base bottom portion 117.

(g) The sectional shape of the door weather strip 104 is not limited to that described in the embodiment. For example, a configuration may be adopted in which the bridge portion 120 or the like is omitted.

(h) In the embodiment, the supporting projecting portion 134 is brought into press contact with the internal surface of the external side wall portion 119 of the attaching base portion 115 in the vicinity of the root portion of the sub-seal lip 125. The press contact portion of the supporting projecting portion 134 is not limited thereto, and hence, the same function and advantage as those described above are provided as long as the supporting projecting portion 134 is made to be brought into contact with at least the internal surface of the external side wall portion 119 of the attaching base portion 115.

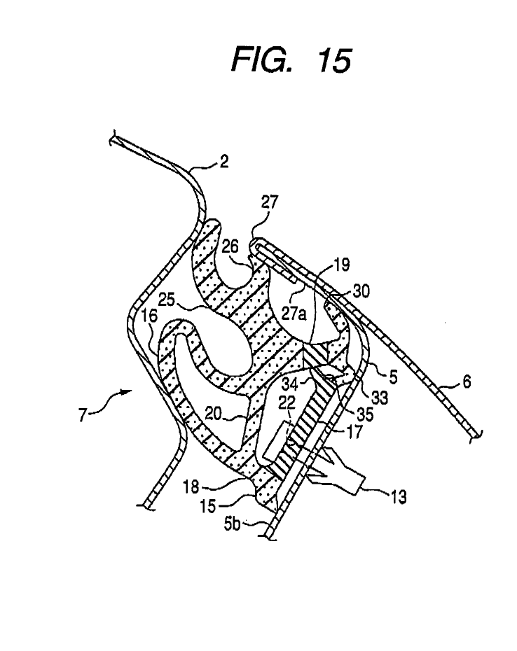

As is shown in FIG. 15, the base bottom portion 117 including the supporting projecting portion 134 and part of the external side wall portion 119 with which the supporting projecting portion 134 is brought into press contact are made to be formed from a material having higher rigidity such as, for example, the EPDM solid rubber, the form stability is increased, whereby the aforesaid functions and advantages are provided in an ensured fashion.

What is claimed is:

1. A door weather strip attached to a peripheral portion of a door of a vehicle for sealing between a circumferential edge of a door opening and the door, comprising in at least a part of an upper side portion that is provided along an upper edge portion of the door:
an attaching base portion adapted to be fixed to an attaching surface formed on a door panel by a fixing means;
a first seal portion adapted to be brought into press contact with the circumferential edge of the door opening when the door is closed;
a second seal portion adapted to be brought into press contact with the circumferential edge of the door opening in a position lying further transversely outwards than the position where the first seal portion is in press contact with the circumferential edge of the door opening;
a third seal portion adapted to be brought into press contact with a side wall surface of the door panel which is formed on an external side of the attaching surface in such a manner as to intersect the attaching surface;
a fourth seal portion formed in such a manner as to project from a side wall portion of the attaching base portion that is provided to face the side wall surface of the door panel and adapted to be brought into press contact with the side wall surface of the door panel in a position lying closer to the attaching surface than the position where the third seal portion is in press contact with the side wall surface of the door panel; and
a fifth seal portion formed in such a manner as to project from a base bottom portion of the attaching base portion which is provided to face the attaching surface of the door panel and adapted to be brought into press contact with the attaching surface in a position lying further transversely outwards than the fixing means; wherein a thickness of at least a connecting portion between the fifth seal portion and a main body portion of the base bottom portion is made thinner than a thickness of the main body portion of the base bottom portion.

2. The door weather-strip according to claim 1, further comprising:
a supporting projecting portion formed in such a manner as to project inwards from the base bottom portion of the attaching base portion in a position lying further transversely inwards than the fifth seal portion and adapted to be brought into press contact with an internal surface of the external side wall portion of the attaching base portion at least when the door is closed to thereby form a pseudo-hollow portion together with the base bottom portion and the external side wall portion of the attaching base portion.

3. The door weather strip according to claim 2, wherein the second seal portion is formed in such a manner as to project outwards from the external side wall portion of the attaching base portion, and wherein the supporting projecting portion is brought into press contact with a connecting portion between the second seal portion and the external side wall portion or the vicinity thereof.

4. The door weather strip according to claim 2, wherein the fifth seal portion is formed substantially into a V shape in-cross section, and the pseudo-hollow portion having a substantially rectangular sectional shape is formed when the supporting projecting portion is brought into press contact with the internal surface of the external side wall portion of the attaching base portion.

5. The door weather strip according to claim 1, wherein the fifth seal portion is provided at an external end portion of the base bottom portion in a width direction thereof or in the vicinity thereof.

6. The door weather strip according to claim 1, wherein a thickness of a connecting portion between at least the fifth seal portion and a main body portion of the base bottom portion is made thinner than a thickness of the main body portion of the base bottom portion.

7. The door weather strip according to claim 1, wherein the fifth seal portion is formed into a V shape in cross section.

8. The door weather strip according to claim 1, wherein at least the attaching base portion and the fifth seal portion are formed integrally of a sponge elastic material.
